(19) United States
(12) Patent Application Publication
(10) Pub. No.: US 2006/0185331 A1
(43) Pub. Date: Aug. 24, 2006

(54) Continuous duty equine halter

(76) Inventor: Joan Pretty, Lanark (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/367,395

(22) Filed: Mar. 6, 2006

Related U.S. Application Data
(63) Continuation-in-part of application No. 10/932,050, filed on Sep. 2, 2004.
Application No. 10/932,050 is a continuation-in-part of application No. 10/464,372, filed on Jun. 19, 2003, now abandoned.

(51) Int. Cl. B68B 1/02

(52) U.S. Cl. 54/24

(57) ABSTRACT

A safety halter includes a nose band which is formed of an upper nose band connected to a lower nose band by connecting rings. A crown piece is connected to a throat latch by connecting rings. The crown piece and throat latch are joined to the nose band by cheek pieces. A connecting piece extends between the lower nose band and the throat latch. The crown piece, throat latch and lower nose band are provided with safety release mechanisms which will separate when subjected to a tension exceeding a predetermined threshold. The strategic location of the safety release mechanisms ensures that the safety halter will release regardless of which part of the safety halter becomes ensnared providing greater safety than conventional halters and conventional safety halters.

### CROSS-REFERENCE

The present application is a continuation-in-part of U.S. patent application Ser. No. 10/932,050 (Kemp et al.) entitled “Continuous Duty Equine Halter” filed on Sep. 2, 2004, which is a continuation-in-part of U.S. patent application Ser. No. 10/464,372 (Kemp et al.) entitled “Continuous Duty Equine Halter” filed on Jun. 19, 2003, the entirety of which is hereby incorporated by reference

### FIELD OF THE INVENTION

The present invention relates to an equine halter and more particularly to a continuous duty equine halter.

### BACKGROUND OF THE INVENTION

Halters are used to enable horse trainers and owners to more easily and safely groom, control and lead horses. Where animals such as horses are sent to pasture without a halter, they can be elusive and evade capture for a considerable period of time. If these are working animals, the time wasted capturing the animal results in lost revenue for the owner. Safety for riding students or novice animal handlers provides a further reason for leaving a halter on the animal. It is understood that capturing even a docile animal is far safer when the animal is wearing a halter.

A reader skilled in the art will be aware that a conventional halter comprises a plurality of straps adapted to encircle the head of the animal and be non-releasable when worn. Once applied the halter provides a convenient means for securing and leading the animal. This is particularly important where the animal is difficult to capture in a large field, pasture area or has escaped from an enclosure.

There is considerable disagreement in the equine industry, whether these same animals should be left unattended while wearing halter devices. It is common knowledge that equine livestock, in particular horses, are at risk of injury or death due to strangulation or entrapment should halters, bridles or other tack equipment become ensnared during periods when the animal is not under supervision.

The problem with leaving the halter on the animal is the same as with other tack. The straps and hardware of the halter can become ensnared in trees, shrubs or the limbs of the animal itself. Often foals will play and jump when in a group, thus increasing the likelihood of entrapment between animals, further increasing risk of injury or death.

In addition to being injured or killed as disclosed above, animals can escape from the confines of the paddock or pasture area. If roads abut these lands, there is a further possibility of the animal being struck by vehicles at night due to the inability of the driver to see the animal.

Conventional halter designs can cause problems with the horse in other ways. Heavy leather or thick weave nylon halters, particularly those with rough or irregular hardware, when left on for many hours can chafe or wear the hair or skin leaving marks that are not acceptable when showing the animal. As a result standard riding, work or show tack should never be left on an unsupervised animal.

The dichotomy of an animal wearing or not wearing a halter while unattended has resulted in earlier attempts to correct the diverging issues of safety and convenience in the form of safety halters.

For example, U.S. Pat. No. 4,094,131 discloses a safety halter comprising a crown piece strap having two sub-strap components. A first weak strap and releasable connection will separate upon the imposition of a force, such as that caused when an animal becomes ensnared and attempts to free itself. A second stronger strap and releasable connection, bridges the first weaker strap, providing a non-breakable member for securely holding the animal while under supervision. A problem with this arrangement is that it is susceptible to user error. For example due to inattention or inexperience, the halter may be unintentionally used while the non-breakable member is engaged resulting in compromised safety for the horse.

Furthermore, releasable halter systems that comprise sections that break away are commonly fabricated of leather, which tends to be relatively heavy and non-pliable. Such halters are known to cause considerable chaffing and damage to the animal's skin when worn for long periods of time. Such break away halters require the purchase of additional components to replace the damaged section after an entrapment. This requires the owner incurring additional cost than would otherwise be necessary.

Referring to FIG. 1, there is shown a conventional equine leather halter 10. Such halters are common throughout the world. When the weight, thickness and grain structure of the leather is taken into account, it is possible to fabricate the halter to break when subjected to abnormal loading forces. The main drawbacks with leather halters tend to be weight, hair and skin chaffing of the animal, initial purchase cost and care for the leather material. In addition, environment can affect the breaking strength, for example, wet and dry cycles when the leather is exposed to water rendering the breaking strength unpredictable or unacceptable.

Referring now to FIG. 2, there is shown a detail of the leather halter 10 of FIG. 1. This detail illustrates a typical fault of many conventional halters, wherein hardware, clips, buckles and similar fasteners 15 form an irregular surface or have undesirable protrusions or corners with the result that the fastener can abrade or dig into the skin of the animal. Furthermore, when the halter breaks under load, this hardware can form projectiles that are dangerously close to the horse's eyes.

Alternatives to leather material include heavy webbed nylon or other artificial materials. Materials such as nylon provide the advantages of being generally less expensive and requiring little maintenance but they are known to be virtually indestructible, and so will not release unless modified, for example, by the addition of mechanisms of conventional safety halters. It is also known that nylon halters suffer from the same problems of chaffing as discussed above in the context of leather halters. In addition, conventional safety release mechanisms are still problematic.

Miller in U.S. Pat. No. 4,376,366, teaches a conventional halter assembly fitted with releasable buckle. The buckle is fitted with a spring loaded clip assembly and excessive longitudinal force exerted on the spring will release the strap from the buckle.

However, an associated problem is that spring release clips are subject to sudden release due to “jerking” of a control lead affixed to the animal, which may cause premature release and subsequent startling of the animal. Further, metal clips and other similar materials are subject to wear and oxidation causing the spring release pressure to become un-calibrated over time or to fail.

Horrigan in U.S. Pat. No. 4,502,265 teaches another arrangement. This halter comprises a two-section releasable fastener arranged with one section on each part of two longitudinally overlapping straps. When these straps are subjected to longitudinal forces in excess of the pre-determined load limit, the sections release, freeing the animal. Horrigan teaches that a “clip and ring” fastener arrangement bridging the two-section releasable fastener provides a means of making the halter un-releasable.

Conventional systems that utilize longitudinally overlapping two section releasable fasteners assume that the release force is always applied longitudinally. If the release force is applied perpendicularly or tangentially to the releasable section, the section will release at a greatly attenuated level, causing nuisance releasing.

The conventional halters discussed above base the sole mechanism of release on either mechanical clips, weak section pieces, or two-section releasable fastener material located in the crown piece only. A person skilled in the art will recognize that an animal can become entrapped in such a manner that forces are distributed throughout the halter strap material. If such a condition were to arise, the longitudinal forces applied to the releasable section may be attenuated below the release force of the section, resulting in an unpredictable release strength and compromising the level of safety afforded. In addition, in those instances where the halter does release successfully, metal clips, buckles and other sharp-edged hardware can be a safety hazard, while “break-away” components such as weak links or strap sections must be replaced before the halter can be re-used.

A further limitation of prior art halters is that each of the straps have the same, or closely similar construction, and so have substantially the same stiffness. This means that the halter can readily shift on the horse's head, reducing effectiveness of the halter and possibly creating a hazard. This situation is increased for the case of nylon safety halters in which the crown piece includes a length of leather strap as a “break-away element. With these halters, the leather strap is typically connected at one side of the halter, and the difference in weight and flexibility between the leather and nylon portions of the crown piece (as well as the associated buckles) inevitably causes the halter to shift into an unbalanced position on the horse's head.

### SUMMARY OF THE INVENTION

Accordingly, it is an object of the present invention to provide a halter that obviates or mitigates one or more problems associated with conventional halters.

Another object is to provide a halter wherein the force required to operate the releasable sections of the halter will be constant, predictable and reliable regardless of the location of application of freeing forces.

It is a further object of the present invention to eliminate the need for buckles, fasteners, clips or other such items to reduce the possibility of skin damage due to scratches or bone fractures due to high abnormal loading forces during entrapment.

It is a further object of the present invention to provide a halter, which is light in weight and non-chaffing relative to leather or heavy weave nylon halters. One preferred embodiment of the present invention utilizes a “tubular, high tensile strength” fine weave nylon material. Such material can be fabricated with additional linings of suede, fine leather, deerskin or other material on the animal side of the halter, to further prevent chaffing or skin damage.

A preferred embodiment of the present invention provides a reflective material applied to the outside of the halter straps in locations to facilitate increased night time visibility. The reflective material affords an element of safety should the animal escape its controlled environment and enter a roadway. The reflective material greatly increases the visibility of the animal under the light of vehicle headlamps. Additionally, such reflective material can aid the owner in locating the animal or, alternatively, spot a “dropped halter” in a dark field by using a flashlight reflecting on said reflective material.

Another object is to provide a safety halter that fits the animal well or not at all, thereby reducing the possibility that a poorly fitting halter will compromise the safety and comfort of the animal.

Another object is to provide a universal or nearly universal halter that can be used for different functions including leading, trailering, working, grooming, showing, etc.

The present safety halter releases upon the application of above normal load forces. More particularly the present invention relates to a halter wherein the force required to operate the releasable sections of the halter will be relatively constant, predictable and reliable regardless of the location of application of said above normal forces. It includes a plurality of straps adapted to removably encircle the head, neck and face area of an equine animal.

According to an aspect of the present invention, a halter according to the present invention includes safety release mechanisms strategically located in different sections of the halter as opposed to a single safety release provided on the crown piece.

According to an aspect of the present invention, there is provided An equine safety halter, comprising: a nose band for encircling a horse's nose, the nose band comprising an upper nose band and a lower nose band, a first end of the upper nose band and a first end of the lower nose band connected to a first connecting member and a second end of the upper nose band and a second end of the lower nose band connected to a second connecting member; a crown piece for fitting behind ears of a horse and over a poll of the horse, a first end of the crown piece being connected to a third connecting member and a second end of the crown piece being connected to a fourth connecting member; a throat latch, a first end of the throat latch being connected to the third connecting member and a second end of the throat latch being connected to the fourth connecting member; a first cheek piece extending between the first and third connecting members; a second cheek piece extending between the second and fourth connecting members; and a connecting piece extending between the lower nose band and the throat latch, wherein the connection between the first end of the lower nose band and the first connecting member is non-destructively releasable upon application of a predetermined amount of tension, wherein the connection between the first end of the crown piece and the third connecting member and the connection between the second end of the crown piece and the fourth connecting member are non-destructively releasable upon application of the predetermined amount of tension; and wherein the connection between the first end of the throat latch and the third connecting member being non-destructively releasable upon application of the predetermined amount of tension so that any circuit formed of components of the halter is releasable upon application of tension that exceeds a pre-determined tension threshold.

According to another aspect of the present invention there is provided A halter for a horse, the halter comprising: a plurality of straps for encircling a head of the horse, the straps including: a nose band, a crown piece, a throat latch and cheek pieces, the straps being interconnected by connecting members to form one or more circuits, wherein each circuit comprises a safety release for opening the circuit when the safety release is in tension and said tension exceeds a predetermined tension threshold.

A reader who is a skilled in the equestrian arts will understand the concerns regarding safety and convenience in handling an animal and the unpredictable ways in which they can become ensnared. Advantageously, the present invention offers redundant protection means to reduce the possibility of injury or death in such instances. Furthermore, there are other means of assembling such components into a continuous duty equine halter system suitable for unsupervised wearing by an animal, without departing from the scope of the present invention.

Other advantages, objects and features of the present invention will be readily apparent to those skilled in the art from a review of the detailed description of the preferred embodiment in conjunction with the accompanying drawings and claims.

### BRIEF DESCRIPTION OF THE DRAWINGS

The embodiments of the invention will now be described with reference to the accompanying drawings, in which similar references are used in different Figures to denote similar components:

FIG. 1 is a view of a conventional equine leather halter;

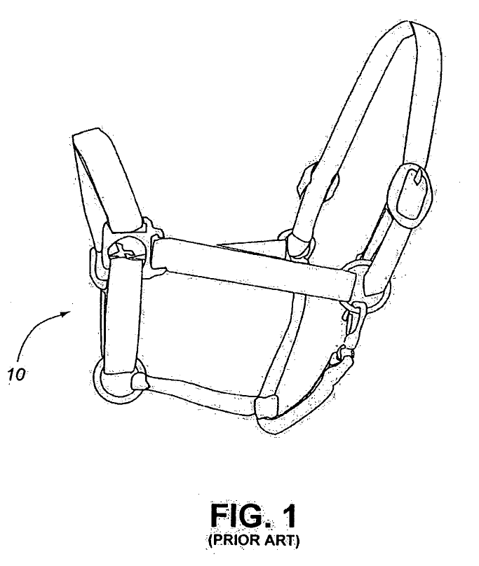

FIG. 2 illustrates a detail of the halter of FIG. 1;

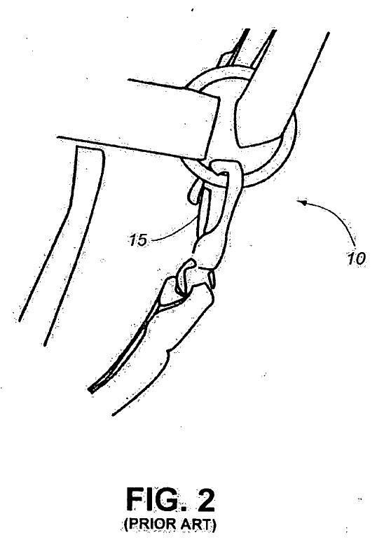

FIG. 3 shows an embodiment of the present invention as worn by a horse;

FIG. 4 is a perspective view of the embodiment of FIG. 3;

FIG. 5 is a schematic view of the embodiment of FIG. 3;

FIG. 6 is a diagram illustrating the topology of the embodiment of FIG. 3;

FIG. 7 is a diagram of the embodiment of FIG. 3 in an unassembled state;

FIGS. 8a and 8b illustrate a blind spot in the embodiment of FIG. 3; and

FIG. 9 illustrates the crown piece in greater detail.

### DETAILED DESCRIPTION OF PREFERRED EMBODIMENTS

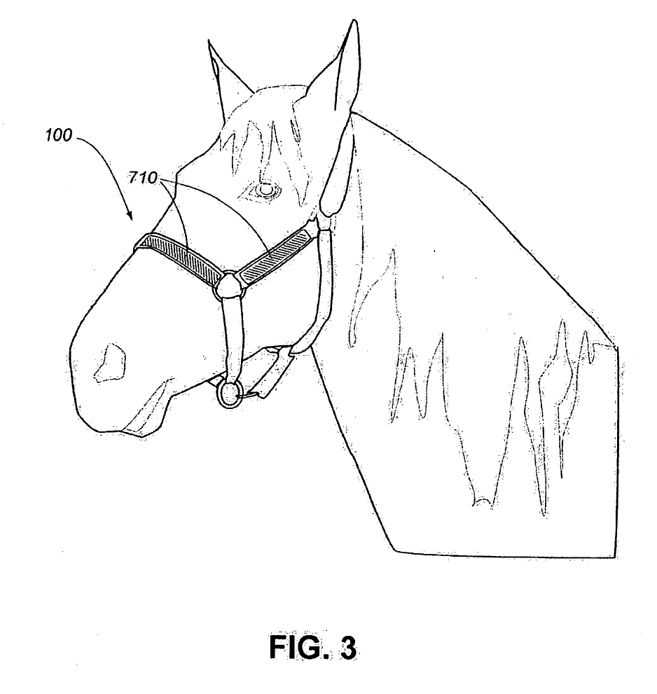

The present invention relates to a halter for equine animals, for example horses, that can be used continuously and for numerous activities including trailering, training, working and grazing while reducing the danger of injuring the horse resulting from chafing, bruising and ensnarement. FIG. 3 illustrates an example halter 100 according to the present invention as worn by a horse.

The expression “halter component” includes the major elements of the halter including halter pieces such as upper nose band, lower nose band, crown piece, throat latch, left and right cheek pieces and connecting elements such as connecting rings.

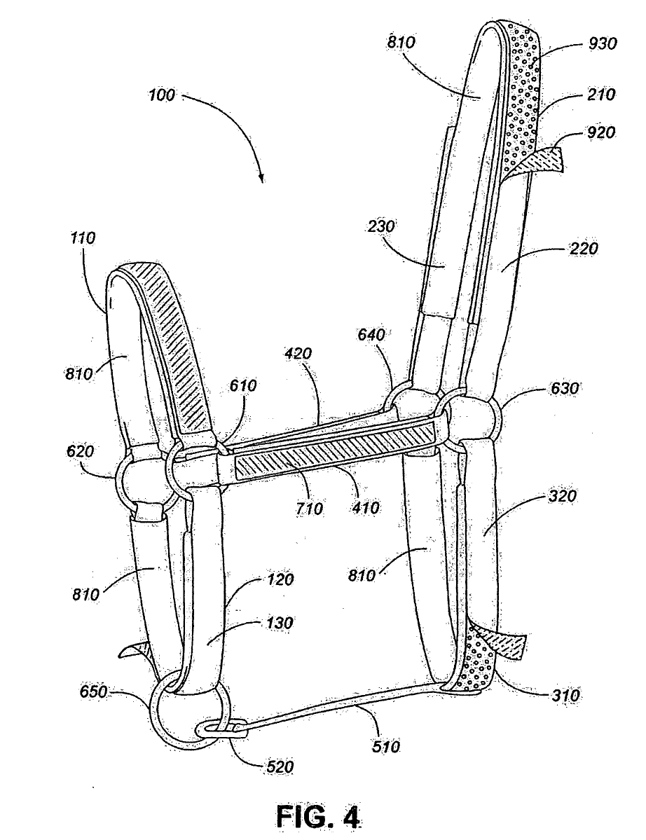

The expression “circuit” refers to a chain of halter components that form a closed loop and that presents a danger that the horse can become ensnared or restrained by the closed loop. A closed loop is a chain or connected sequence of two or more components in which the first halter component is also connected to the last halter component. For example, referring to FIG. 4 the following halter components form a circuit: upper nose band 110, connecting ring 610, lower nose band 120 and connecting ring 620. By contrast, the connecting ring 630 is not a circuit because it is a single halter component and not a connected sequence of two or more halter components. Furthermore, the connecting ring 630 is by itself incapable of ensnaring or restraining the horse in the context of ordinary use of a halter.

FIG. 4 shows one preferred embodiment of the present invention. The halter 100 comprises a nose band for fitting around the horse's nose. The nose band includes an upper nose band 110 and a lower nose band 120. Upper and lower nose bands are attached to connecting members, for example, connecting rings 610, 620. Crown piece 210 fits over the horse's poll and behind the horse's ears (see also FIG. 3). Throat latch 310 fits over or adjacent to the horse's jowl and below the horse's throat. The throat latch is connected to the crown piece by connecting rings 630, 640. The nose band is joined to the crown piece and throat latch by cheek pieces 410, 420 which are connected to the connecting rings 610, 620, 630, 640. A connecting piece or connection strap 510 extends between the throat latch 310 and the lower nose band 120. The connecting strap 510 includes a connecting member, namely D-ring 520. D-ring 520 is connected to connecting ring 650 which is provided on the lower nose band 120. The other end of the connecting strap 510 forms a loop which loops around throat latch 310.

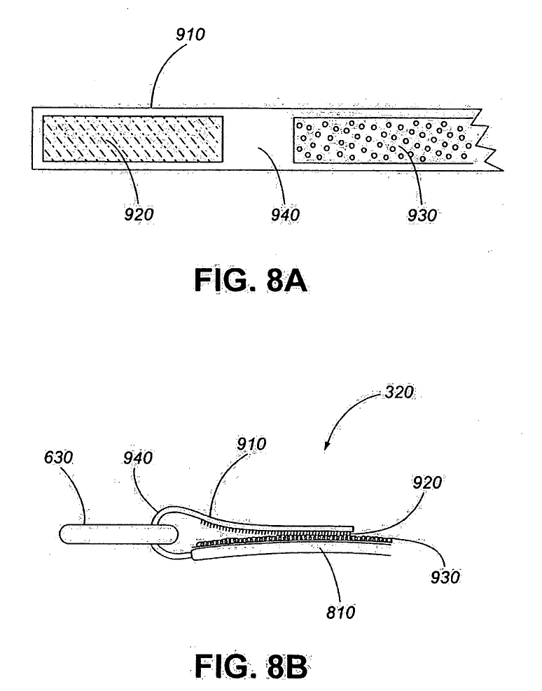

The strap members, including upper and lower nose bands 110, 120, cheek pieces 410, 420, crown piece 210 and throat latch 310 are preferably made of a strong durable material such as leather or synthetic webbing. Preferably these strap members are lined with a suitable liner 810 such as deerskin to reduce chafing and abrading. More preferably the liner 810 is formed by sewing or otherwise attaching a piece of deerskin to the halter piece material, such as synthetic webbing. This is illustrated in FIG. 8b.

Crown piece 210 includes two safety release mechanisms, namely left safety release 220 for separating the crown piece 210 from connecting ring 630 and safety release 230 for separating the crown piece from connecting ring 640. The throat latch 310 includes safety release 320 for separating the throat latch 310 from connecting ring 630. The lower nose band includes safety release 130 for separating the lower nose band from the connecting ring 610. In addition, the connecting strap can be provided with a similar safety release (not shown) for separating the connecting strap from connecting ring 650.

The safety releases will remain coupled during normal load forces associated with routine activities. However, the safety releases are designed to separate in a hazardous situation when the safety release is subjected to tension forces exceeding the normal load. Examples of normal load forces include leading of the animal from one place to another or restraining on cross ties while grooming. Forces exceeding the normal force level can include entrapment due to snaring of the halter on a tree, second animal or the animal's own appendage. More specifically, a force exceeding a predetermined threshold will separate the safety release.

Referring to FIGS. 4, 8a and 8b, FIGS. 8a and 8b show in detail a portion of the halter 100 of FIG. 4. The safety release 320 of the example embodiment comprises a hook and loop releasable fastener, for example, Velcro.RTM. brand hook and loop fastener. A hook and loop fastener includes a “hook” portion 920 and a “loop” portion 930 so that when they are brought together the hooks engage the loops. Note according to the present embodiment the soft loop portion 930 faces outward away from the horse while the rough hook portion 920 faces inward toward the horse. This arrangement reduces the amount of hair, fiber and detritus that is collected by the hook portion. Although this type of fastener can be easily separated by peeling i.e. tension in a direction normal to the plane of the hook and loop interface, it is strong in a direction in that plane. In the present example, the longitudinal direction of the strap is in the plane of the hook and loop interface. Accordingly, the hook and loop fastener affords a reusable mechanism which is not destroyed upon release.

The hook and loop portions 920, 930 can be attached to the halter pieces by stitching although any other suitable attachment means can be used. The hook portion and loop portion are attached on the same face of the halter piece, for example at a portion of nylon webbing 910. Separating the hook portion and the loop portion is a “blind spot” 940 where the halter piece, for example, nylon webbing, is exposed. The exposed halter piece forms the body of the loop that will connect the halter piece to a connecting member such as a connecting ring. The size of the blind spot is determined to within predetermined limits as an indicator of proper fit. If either the hook portion 920 or the loop portion 930 is required to form the loop around the connecting member then the halter does not fit the horse properly and should not be used on that particular horse. Instead, a different sized halter can be used. In a commercial context, various sizes of horses can be accommodated by different sizes of halters. For example halters can be sized according to Arabian horse, regular horse and large horse.

The release strength of the hook and loop depends on a number of factors including the length and width of the hook and loop portions. In order to avoid nuisance releasing, the hook and loop fastener should not release unless the (longitudinal) tension in the fastener exceeds a predetermined threshold. Preferably the predetermined threshold is in the range of 150 to 250 pounds of force.

The presence of multiple safety releases and their position in the halter 100 greatly increase the possibility that an ensnared horse can free itself under a wide variety of circumstances. Referring to FIG. 4, a circuit is formed by the upper nose band 110, the connecting ring 610, the lower nose band 120 and the connecting ring 620. Similarly, another circuit is defined by the crown piece 210, connecting ring 630, the throat latch 310 and connecting piece 640. A third circuit includes the crown piece 210, connecting ring 630, left cheek piece 410, connecting ring 610, upper nose band 110, connecting ring 620, right cheek piece 420 and connecting ring 640. Of course, other circuits can be identified from FIG. 4.

The first circuit includes safety release 130 provided on the lower nose band. The second circuit includes safety releases 220, 230 found on the crown piece and safety release 320 provided on the throat latch. The third circuit includes safety releases 220, 230 found on the crown piece. Each of these example circuits includes a safety release which will release if the tension in the circuit exceeds a predetermined tension threshold. Furthermore, placement of the safety releases in the present example embodiment ensures that any circuit in the halter contains one or more safety releases.

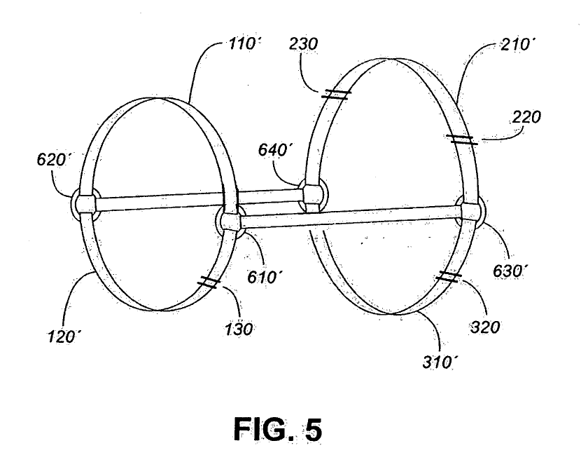

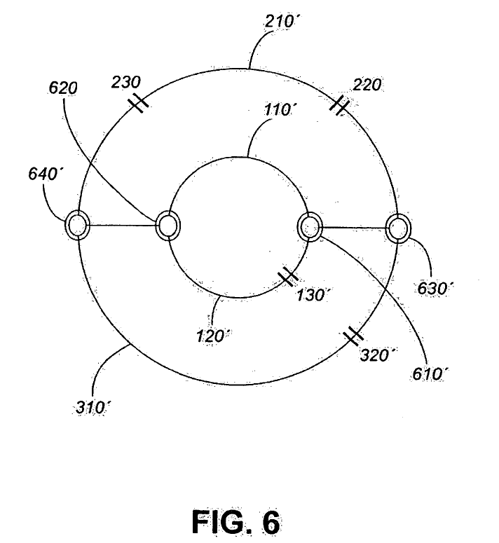

FIG. 5 is a simplified schematic of the halter of FIG. 4 showing the nose band, cheek pieces, crown piece and throat latch. The reference numbers correspond with their counterparts of FIG. 4. This is further abstracted in FIG. 6 which shows the topology of the halter 100, again with reference numbers corresponding to their counterparts of FIG. 4. It is clear from inspection of FIG. 6 that any circuit or loop in FIG. 6 must pass through one of the four safety releases identified in FIG. 4. These Figures have been simplified to omit the connecting strap, however, a similar analysis applies. If desired, the connecting strap can include a similar safety release.

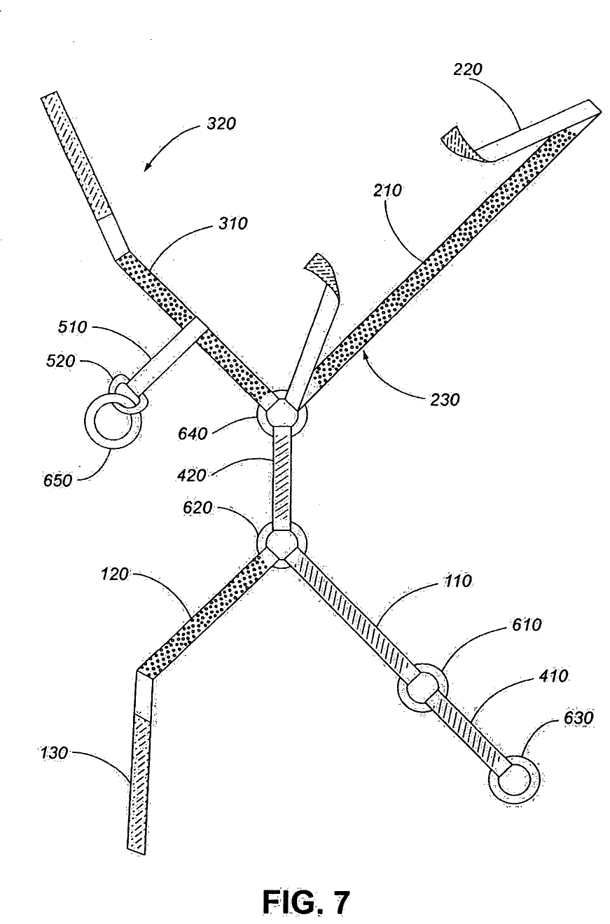

For greater clarity FIG. 7 illustrates the halter 100 of FIG. 4 in a disassembled state in which all safety releases have been opened. FIG. 7 reveals that with all safety releases open, no circuit is possible. Conversely, any circuit must contain a safety release.

By contrast, a conventional safety halter typically has a single safety release corresponding to safety release 220 found on crown piece 210. This results in the possibility that a horse can become ensnared, for example, by the nose band. The horse will try to extricate itself from the situation by moving appropriately. A first reaction of the horse is to move backwards, however, this is not always possible. For example, the horse may be facing outward while in its stall or the horse may perceive a hazard from behind, such as a barking dog, and attempt to move forward in an effort to get away. In this circumstance, in an attempt break free, the forces exerted upon the halter, specifically the nose band, will not necessarily be effectively transmitted to the crown piece with the result that the nose band substantially bears the force exerted by the horse. This failure of a conventional safety halter can result in injuries or even death for the animal.

A simpler example of the hazard presented by a conventional safety halter is where the horse in scratching its face ensnares its leg in the nose band. The leverage of the raised leg is greatly reduced and the force exerted by the horse may be borne by the nose band, again without distribution to the safety release of the crown piece resulting in failure of the conventional safety halter to release.

The important factor in this example is the presence of a circuit as discussed above that does not include a safety release.

Referring to FIGS. 3 and 4, this embodiment of the present invention details strategically located light reflective surfaces, for example, reflective surface 710 which increase visibility should the animal escape onto a roadway at night. The specific number of reflective surfaces and their placement on the halter can vary depending on the embodiment. Also detailed is a soft surface finish or liner 810, e.g. of deerskin leather for further reducing surface abrasion and preventing hair and skin chaffing of the wearing animal.

Referring now to FIG. 3 there is shown a horse wearing an embodiment of the present invention halter 100. The horse is in a darkened area, as would be found in a pasture or roadway at night. The reflective material 710 is glowing brightly in the light of a flashlight, car headlamps or other source of illumination. The reflective surface 710 greatly increasing the visibility of the horse.

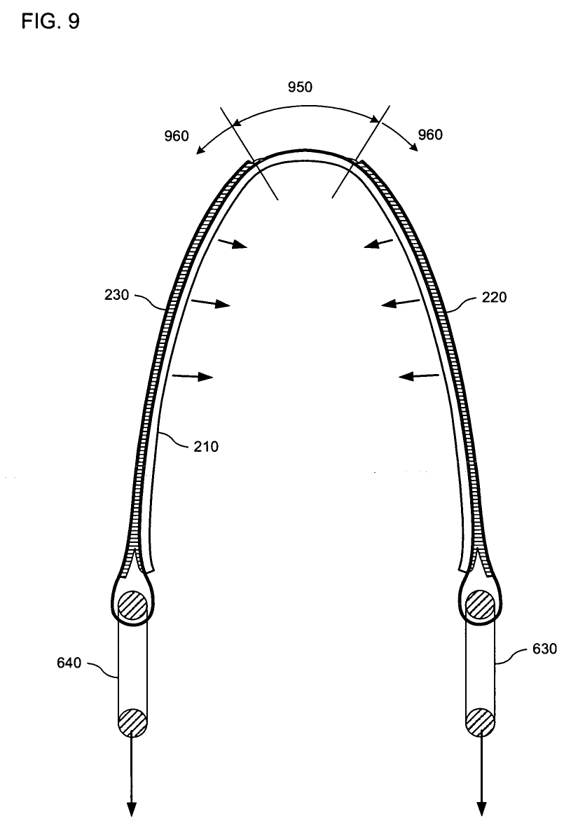

FIG. 9 illustrates the crown piece 210 and connecting rings 630 and 640 in greater detail. As may be seen in FIG. 9, the left and right safety releases 220 and 230 are designed to overlap a majority of the length of the crown piece 210, thereby forming a comparatively short, centrally located poll portion 950 bounded by side portions 960 extending to respective opposite ends of the crown piece 210. Within each side portion 960, the hook and loop fastener 920,930 links the material of the safety releases 220, 230 to the overlapped material of the crown piece 210. As a result, the stiffness of the side portions 960 is determined by the composite structure formed by the linked safety release 220, 230, crown piece 210 material and the intervening hook and loop fastener 920,930.

On the other hand, within the poll portion 950, no overlapping occurs. In some embodiments, this may be obtained by omitting hook and loop fastener 920,930 within this portion of the crown piece 210. In other cases, the length of each safety release 220, 230 and the blind region 940 can be selected to ensure that the safety releases 220, 230 will not extend into the desired poll portion 950. As noted above, the length of the blind region 940 is preferably selected to define an allowable adjustment range of the halter, thereby providing an indication of proper fit. Halters may be sized for different types of horses (e.g. Arabian, regular horse, large horse etc.). These same considerations can also be applied to the poll region 950 of the crown piece 210. More particularly, the length of the poll region can differ according to the halter (or horse) size, so that it corresponds with the distance between the horses ears. In other words, the length of the poll region 950 can be matched to the range of size adjustment provided by the blind region 940 to ensure that the poll region 950 does not extend past the horse's ears.

As will be appreciated, because the pole region 950 does not include any overlapping material from either safety release 220, 230, its stiffness will be significantly lower than that of the two side portions 960. As a result, the poll region 950 tends to form a “hinge”, about which the two side regions 960 will naturally pivot. One effect of this hinging action is that the halter will naturally drape symmetrically about the horse's head, and will have a tendency to return to a symmetrical position if accidentally dislodged. Another effect is that when tension is applied to the connector rings 630, 640 (e.g. due to a trainer applying downward pressure on a lead line attached to the connecting ring 650 on the lower nose band 120), as shown by the arrows in FIG. 9, the two side portions 960 will apply significant inward pressure on both sides of the horse's head. Most of this inward pressure will be exerted at or near the transition between the pole and side regions 950, 960, which lies immediately behind the horses ears when the halter is properly fitted. As will be familiar to those familiar with horse anatomy, the area behind the horse's ears is a “pressure point” which is highly sensitive to inwardly-directed pressure. As a result, the poll and side regions 950, 960 of the crown piece 210 exploit the horse's anatomy to maximize the horse's response to downward pressure on the halter. This improves the safety of the halter (by reducing the horse's tendency to pull back when the halter becomes ensnared), and provides a highly effective training aid, by amplifying pressure applied by a handler.

Numerous modifications, variations and adaptations can be made to the particular embodiments of the invention described above without departing from the scope of the invention, which is defined in the claims.

We claim:

1. An equine halter including a crown piece for fitting behind ears of a horse, the crown piece comprising a centrally located poll region and a pair of side portions extending from the poll region to respective opposite ends of the crown piece, a stiffness of each side portion being greater than that of the poll region.

2. An equine halter as claimed in claim 1, wherein each side portion comprises an overlap region of the crown piece and a respective safety release.

3. An equine halter as claimed in claim 2, further comprising a hook and loop fastener coextensive with the overlap region for connecting the safety to the crown piece.

4. An equine halter as claimed in claim 1, wherein a length of the poll region is less than or equal to a distance between the ears of a horse.

5. An equine halter as claimed in claim 2, wherein the respective safety release comprises an extension of the crown piece material.

6. An equine halter as claimed in claim 5, wherein each safety release mechanism comprises an integrally formed indicator of proper fit of the halter.

7. An equine halter as claimed in claim 6, wherein the indicator comprises a blind spot of separating respective hook and loop portions of a hook and loop fastener, a length of the blind spot being proportional to a range of size adjustment of the halter

8. An equine halter as claimed in claim 7, wherein the range of size adjustment of the halter is selected such that a maximum length of the poll region does not extend past a horse's ears.

9. An equine halter as claimed in claim 1, further comprising:
a plurality of straps including a throat latch; a nose band; and a pair of cheek pieces;
a first pair of members for interconnecting the nose band and the pair of cheek pieces;
a second pair of members for interconnecting the throat latch, the cheek pieces and the crown piece; and
a respective safety release mechanism integrally formed with at least one end of each of the nose band and the throat latch.
